(19) United States
(12) Patent Application Publication
(10) Pub. No.: US 2008/0238865 A1
(43) Pub. Date: Oct. 2, 2008

(54) Electrophoretic display device, method for driving electrophoretic display device, and electronic apparatus

(75) Inventor: Hiroshi Maeda, Hara-mura (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/075,884

(22) Filed: Mar. 15, 2008

(30) Foreign Application Priority Data
Mar. 29, 2007 (JP) 2007-087669

(51) Int. Cl. G09G 3/34

(52) U.S. Cl. 345/107

(57) ABSTRACT

An electrophoretic display device includes a plurality of pixels which are connected to scanning lines, data lines, a first control line, and a second control line, and which have first electrodes, a second electrode facing the first electrodes, electrophoretic elements which are sandwiched between the first electrodes and the second electrode and which have charged electrophoretic particles, pixel switching elements connected to the scanning lines and the data lines, memory circuits which are connected to the pixel switching elements, which store therein pieces of 1-bit data supplied through the data lines and the pixel switching elements, and which output signals representing the pieces of 1-bit data, and switch circuits which are arranged between the memory circuits and the first electrodes and which electrically connect the first control line or the second control line to the first electrodes. The electrophoretic display device further includes a signal supply unit which supplies first driving signals determining tones of, among the plurality of pixels, pixels having the first electrodes connected to the first control line to the first control line, and which supplies second driving signals determining tones of, among the plurality of pixels, pixels having the first electrodes connected to the second control line to the second control line.

### BACKGROUND

1. Technical Field

The present invention relates to an electrophoretic display device, a method for driving the electrophoretic display device, and an electronic apparatus.

2. Related Art

In recent years, as an example of display devices, an electrophoretic display device employing electrophoretic material has been getting attention. Such an electrophoretic display device includes a circuit substrate in which pixel circuits having switching elements, data lines, scanning lines, and pixel electrodes are formed thereon, a counter substrate including a common electrode formed thereon so as to face the circuit substrate, and electrophoretic elements which include a plurality of microcapsules incorporating positively or negatively charged electrophoretic particles and which are sandwiched between the circuit substrate and the counter substrate. In the electrophoretic display device having such a configuration, when potential differences are generated between the pixel electrodes and the common electrode, the positively charged electrophoretic particles or the negatively charged electrophoretic particles move to a pixel electrode side, and the others move to a counter electrode side. Accordingly, an image is displayed in accordance with color (black or white) of the electrophoretic particles which move to a common electrode side (display surface side).

For example, JP-A-2003-84314 discloses an electrophoretic display device in which a periodic refreshing operation, which is necessary in the related art, can be eliminated since memory circuits capable of storing 1-bite data between switching elements and pixel electrodes are provided.

An example of a display driving method in which SRAMs (Static Random Access Memories) are employed as such memory circuits included in the pixel circuits will be described hereinafter. First, scanning lines are successively selected so that scanning signals are supplied to switching elements in the pixel circuits. The switching elements are controlled to be turned on or off and pieces of image data corresponding to the pixel circuits are supplied through data lines. Then the pieces of image data is stored in the SRAMs in the pixel circuits. For example, in a case where electrophoretic particles for black are positively charged and electrophoretic particles for white are negatively charged, pieces of image data having values of “1” (i.e., a high level) are stored in SRAMs in pixels (pixel circuits) to be used to perform black display whereas pieces of image data having values of “0” (i.e., a low level) are stored in SRAMs in pixels (pixel circuits) to be used to perform white display. In a period in which the pieces of image data are stored, power supply voltages to be supplied to the SRAMs are set to 5V.

Next, the power supply voltages supplied to the SRAMs are changed from 5V to 15V, for example, so that the electrophoretic particles are sufficiently driven. Accordingly, high-level signals having voltage values of 15V are supplied from the SRAMs storing the pieces of image data “1” therein to the pixel electrodes whereas low-level signals having voltage values of 0V are supplied from the SRAMs storing the pieces of image data “0” therein to the pixel electrodes. Note that, by supplying pulse signals having amplitude of 15V to the common electrode, electrophoretic particles move due to electric fields generated due to potential differences between the pixel electrodes and the common electrode. Accordingly, black and white display can be performed.

In the related art, the SRAMs continuously output signals representing pieces of image data stored therein to the pixel electrodes while electric power is supplied to the SRAMs. Specifically, electric fields generated due to potential differences of 5V or 15V are continuously applied to the electrophoretic elements from immediately after the pieces of image data are stored in the SRAMs. Accordingly, it is difficult to perform, for example, gradation display which requires control of electric fields with high accuracy such as halftone display (gray display) or grayscale display including a plurality of tones.

### SUMMARY

An advantage of some aspects of the invention is that there is provided an electrophoretic display device capable of controlling electric fields to be applied to electrophoretic elements with high accuracy and capable of performing high-quality gradation display, a method for driving the electrophoretic display device, and an electronic apparatus.

According to an embodiment of the present invention, there is provided an electrophoretic display device which includes a plurality of pixels which are connected to scanning lines, data lines, a first control line, and a second control line, and which have first electrodes, a second electrode facing the first electrodes, electrophoretic elements which are sandwiched between the first electrodes and the second electrode and which have charged electrophoretic particles, pixel switching elements connected to the scanning lines and the data lines, memory circuits which are connected to the pixel switching elements, which store therein pieces of 1-bit data supplied through the data lines and the pixel switching elements, and which output signals representing the pieces of 1-bit data, and switch circuits which are arranged between the memory circuits and the first electrodes and which electrically connect the first control line or the second control line to the first electrodes, and which includes a signal supply unit which supplies first driving signals determining tones of, among the plurality of pixels, pixels having the first electrodes connected to the first control line to the first control line, and which supplies second driving signals determining tones of, among the plurality of pixels, pixels having the first electrodes connected to the second control line to the second control line.

With this configuration, since timings when driving signals (the first driving signals or the second driving signals) are supplied to the first electrodes are arbitrarily controlled, unlike electrophoretic display devices in the related art, voltages are prevented from being applied to the first electrodes immediately after the pieces of data are stored in the memory circuits. Furthermore, since the tone of the image is determined in accordance with the first driving signals or the second driving signals supplied through the first control line or the second control line, a variety of gradation display may be performed by controlling voltage values or pulse widths of the first driving signals or the second driving signals. Accordingly, electric fields to be applied to the electrophoretic elements are controlled with high accuracy, and therefore, high-quality gradation display can be performed.

The electrophoretic display device according to the embodiment of the invention may further includes a data line driving circuit which supplies the pieces of 1-bit data to the data lines, and a scanning line driving circuit which supplies selection signals representing timings when the pixel switching elements are turned on to the scanning lines. In a data writing period, the data line driving circuit may supply the pieces of 1-bit data to the data lines and the scanning line driving circuit may supply the selection signals to the successively selected scanning lines so that the memory circuits of the pixels stores the pieces of 1-bit data, and in a display period, the signal supply unit may supply the first driving signals to the first control line and supply the second driving signals to the second control line.

Accordingly, since the data writing period in which the pieces of data are stored in the memory circuits of the pixels and the display period in which the first driving signals or the second driving signals are supplied to the first control line or the second control line which are connected to the first electrodes in the data writing period so that an image is displayed are separately provided, voltages are simultaneously applied to the first electrodes of the pixels in the display period. Accordingly, electric fields to be applied to the electrophoretic elements are controlled with high accuracy and quality of gradation display is improved.

Furthermore, when an image of a single tone is to be displayed, in the data writing period, the data line driving circuit may supply pieces of 1-bit data having the same values to the data lines so that the pieces of 1-bit data having the same values are stored in the memory circuits of all the pixels, and in the display period, the signal supply unit may supply first driving signals or second driving signals which represent the single tone to the first control line or the second control line which is connected to the first electrodes of all the pixels.

Accordingly, when the image of a single tone is to be displayed, electric field to be applied to the electrophoretic elements are controlled with high accuracy, and quality of gradation display is improved.

Furthermore, when the image of a single tone is to be displayed and when the pieces of 1-bit data have already been stored in the memory circuits of all the pixels, the data writing period may be skipped and the display period may be entered, and the signal supply unit may supply the first driving signals representing the single tone to the first control line and supply the second driving signals representing the single tone to the second control line.

As described above, when the image of a single tone is to be displayed and when the pieces of 1-bit data have already been stored in the memory circuits of all the pixels, the data writing period may be eliminated. Therefore, reduction of power consumption and improvement of operation speed of the electrophoretic display device are attained.

Moreover, when an image having three or more tones is to be displayed, a combination of two operations may be performed on each of the three or more tones. The two operations include an operation of storing pieces of 1-bit data in, among the memory circuits, memory circuits of the pixels corresponding to one of the three or more tones and storing pieces of 1-bit data, which are different from those stored in the memory circuits of the pixels corresponding to the one of the three or more tones, in memory circuits of the other pixels in the data writing period using the data line driving circuit and the scanning line driving circuit, and an operation of supplying first driving signals or second driving signals which represent the one of the three or more tones to the first control line or the second control line which is connected to the first electrodes of the pixels corresponding to the one of the three or more tones using the signal supply unit, and electrically disconnecting the first control line or the second control line from the first electrodes of the memory circuits of the other pixels in the display period.

By performing the combination of two operations on each of the three or more tones, an image having three or more tones is displayed as grayscale display, for example.

Moreover, when the combination of two operations is first performed, in the data writing period, pieces of 1-bit data having the same values may be stored in the memory circuits of all the pixels using the data line driving circuit and the scanning line driving circuit, and in the display period, first driving signals or second driving signals which represent the one of the three or more tones may be supplied to the first control line or the second control line which is connected to the first electrodes of all the pixels.

Accordingly, an operation of the combination of two operations which is first performed is simplified when the image having three or more tones is displayed, and reduction of power consumption and improvement of operation speed are attained.

Furthermore, when the combination of two operations is first performed and when pieces of 1-bit data have already been stored in the memory circuits of all the pixels, the data writing period may be skipped and the display period may be entered, and the signal supply unit may supply first driving signals representing the one of the three or more tones to the first control line, and supply second driving signals representing the one of the three or more tones to the second control line.

As described above, when pieces of 1-bit data have already been stored in the memory circuits of all the pixels, the operation of the combination of two operations which is first performed is simplified when the image having three or more tones is displayed, and reduction of power consumption and improvement of operation speed are attained.

Moreover, the plurality of pixels may be connected to a positive power supply line and a negative power supply line, the memory circuits may be SRAMs (Static Random Access Memory) which have positive power supply terminals connected to the positive power supply line and negative power supply terminals connected to the negative power supply line. The switch circuits may have first transmission gates used to connect the first electrodes to the first control line in accordance with first signals output from the SRAMs and second transmission gates used to connect the first electrodes to the second control line in accordance with second signals output from the SRAMs. The signal supply unit may supply power supply voltage signals to the positive power supply line and the negative power supply line and supply a common voltage signal to the second electrode.

As described above, since the SRAMs are used as the memory circuits, refreshing operation can be eliminated. Accordingly, circuit configurations are simplified, and reduction of power consumption and improvement of operation speed are attained. Furthermore, since the switch circuits include the first transmission gates and the second transmission gates, the switch circuits having simple configurations are attained. Furthermore, with this configuration, the first transmission gates and the second transmission gates allow the first or second driving signals having voltage levels within a range of power supply voltages of the SRAMs to be supplied to the first electrodes. Therefore, the voltage levels of the first driving signals or the second driving signals may be controlled within the range of the power supply voltages of the SRAMs. (That is, a variety of gradation display is performed.)

Furthermore, the signal supply unit may supply the power voltage signals to the positive power supply line and the negative power supply line in the data writing period and in the display period, and the signal supply unit may electrically break the first control line, the second control line and a line for supplying the common voltage signal in the data writing period.

Accordingly, in the data writing period, current leakages generated in the first control line, the second control line, and the line for supplying the common voltage signal are suppressed, and reduction of power consumption is attained.

Moreover, when an image is continued to be displayed after the display period, the signal supply unit may electrically break the positive power supply line, the negative power supply line, the first control line, the second control line, and the line for supplying the common voltage signal.

Accordingly, when an image is continued to be displayed after the display period, current leakages generated in the positive power supply line, the negative power supply line, the first control line, the second control line, and the line for supplying the common voltage signal are suppressed, reduction of power consumption is attained, and deterioration of display quality is suppressed.

According to another embodiment of the invention, there is provided a method for driving an electrophoretic display device including a plurality of pixels having first electrodes, a second electrode facing the first electrodes, electrophoretic elements which are sandwiched between the first electrodes and the second electrode and which have charged electrophoretic particles. The method includes storing pieces of 1-bit data in memory circuits included in the plurality of pixels, electrically connecting a first control line or a second control line to the first electrodes using switch circuits arranged between the memory circuits and the first electrodes in accordance with the pieces of 1-bit data stored in the memory circuits, and supplying first driving signals representing tones of, among the plurality of pixels, pixels connected to the first control line from the first electrodes to the first control line, and supplying second driving signals representing tones of, among the plurality of pixels, pixels connected to the second control line from the first electrodes to the second control line.

According to the method for driving the electrophoretic display device having the characteristics described above, electric fields to be applied to the electrophoretic elements are controlled with high accuracy, and high-quality gradation display can be attained.

Furthermore, an electronic apparatus according to the embodiment of the invention includes the electrophoretic display device described above.

According to such an electronic apparatus, high-quality gradation display is attained.

### BRIEF DESCRIPTION OF THE DRAWINGS

The invention will be described with reference to the accompanying drawings, wherein like numbers reference like elements.

FIG. 1 is a diagram illustrating a configuration of an electrophoretic display device according to an embodiment of the present invention.

FIG. 2 is a diagram illustrating a circuit configuration of one of a plurality of pixels included in the electrophoretic display device according to the embodiment of the invention.

FIG. 3 is a sectional view illustrating a display unit included in the electrophoretic display device according to the embodiment of the invention.

FIG. 4 is a diagram illustrating a configuration of one of a plurality of microcapsules included in the electrophoretic display device according to the embodiment of the invention.

FIGS. 5A and 5B are diagrams illustrating operation of one of the plurality of microcapsules included in the electrophoretic display device according to the embodiment of the invention.

FIG. 6 is a timing chart illustrating operation of the electrophoretic display device according to the embodiment of the invention.

FIG. 7 is a first diagram illustrating operation of the electrophoretic display device at a time of grayscale display according to the embodiment of the invention.

FIGS. 8A to 8D are second diagrams illustrating operation of the electrophoretic display device at a time of grayscale display according to the embodiment of the invention.

FIG. 9 is a diagram illustrating a first example of a configuration of an electronic apparatus according to an embodiment of the invention.

FIG. 10 is a diagram illustrating a second example of the configuration of the electronic apparatus according to the embodiment of the invention.

### DESCRIPTION OF EXEMPLARY EMBODIMENTS

Embodiments of an electrophoretic display device, a method for driving the electrophoretic display device, and an electronic apparatus according to the invention will be described hereinafter with reference to the accompanying drawings.

### Electrophoretic Display Device

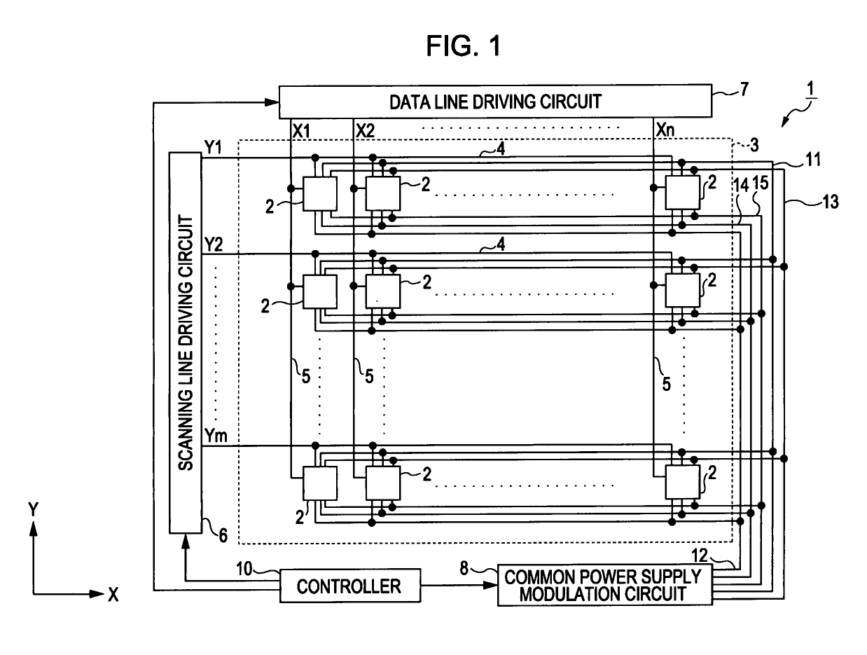

FIG. 1 is a diagram illustrating a configuration of an electrophoretic display device 1 according to an embodiment of the present invention. As shown in FIG. 1, the electrophoretic display device 1 includes a display unit 3, a scanning line driving circuit 6, a data line driving circuit 7, a common power supply modulation circuit (signal supply unit) 8, and a controller 10.

The display unit 3 includes a plurality of pixels 2 arranged in a matrix of m rows and n columns. The scanning line driving circuit 6 is connected to the pixels 2 through a number m of scanning lines 4 (Y1 to Ym) extending in an X-axis direction in the display unit 3. The controller 10 controls the scanning line driving circuit 6 to successively select the scanning lines 4 from the first row to the m-th row and to supply selection signals prescribing timings when driving TFTs (Thin Film Transistors) 24 which are formed in the pixels 2 and which are described later are turned on to the pixels 2 through the selected scanning lines 4. The data line driving circuit 7 is connected to the pixels 2 through a number n of data lines 5 (X1 to Xn) extending in a Y-axis direction. The controller 10 controls the data line driving circuit 7 to supply image signals representing pieces of 1-bit image data (1-bit data) corresponding to the pixels 2 through the data lines 5 including the first column to the n-th column to the pixels 2 (more specifically, source electrodes of the driving TFTs 24). Note that, in this embodiment, low-level image signals represent pieces of image data “0”, whereas high-level image signals represent pieces of image data “1”.

The common power supply modulation circuit 8 is connected to the pixels 2 through a first control line 11, a second control line 12, a first power supply line (positive power supply line) 13, a second power supply line (negative power supply line) 14, and a common electrode power supply line (electric supply line for common voltage signal) 15. The controller 10 controls the common power supply modulation circuit 8 to generate various signals to be supplied to the lines and to be electrically connected to or disconnected from the lines (due to high impedance). Specifically, the common power supply modulation circuit 8 generates first driving signals used to determine tones of the pixels 2 which include pixel electrodes 21 which will be described later and which are connected to the first control line 11, and supplies the generated first driving signals to the first control line 11. Furthermore, the common power supply modulation circuit 8 generates second driving signals used to determine tones of the pixels 2 which includes pixel electrodes 21 connected to the second control line 12, and supplies the generated second driving signals to the second control line 12. Moreover, the common power supply modulation circuit 8 generates power supply voltage signals for SRAMs (Random Access Memories) 25 which will be described later and which are included in the pixels 2, and supplies the generated power supply voltage signals to the first power supply line 13. The common power supply modulation circuit 8 electrically connect/disconnect a ground line to/from the second power supply line 14. Furthermore, the common power supply modulation circuit 8 generates common voltage signals to be supplied to common electrode 22 which will be described later and which are included in the pixels 2, and supplies the common voltage signals to the common electrode power supply line 15.

The controller 10 controls entire operation of the electrophoretic display device 1. The controller 10 controls the scanning line driving circuit 6, the data line driving circuit 7, and the common power supply modulation circuit 8 in response to image signals and synchronization signals supplied from an external higher-level controller (not shown).

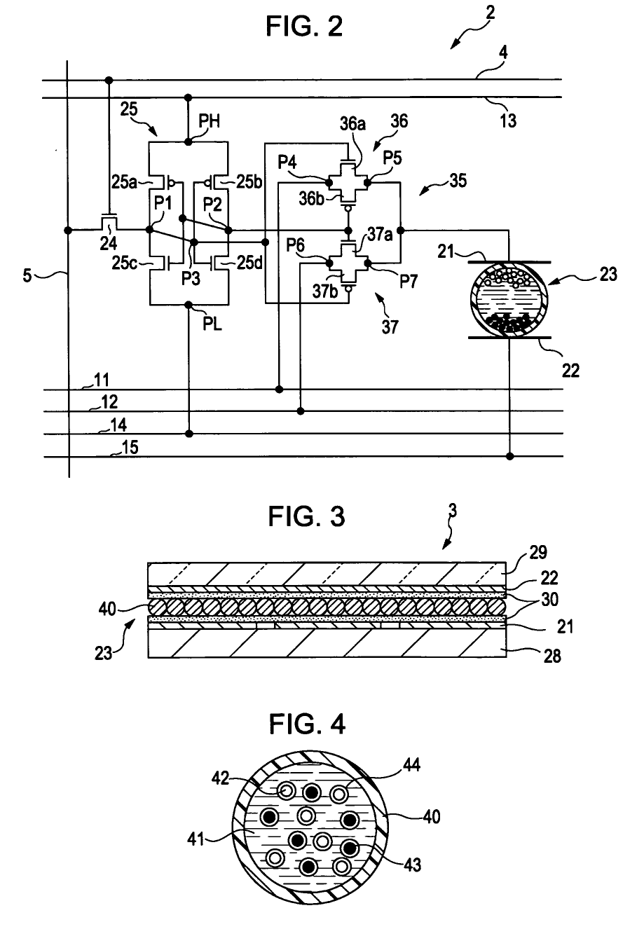

Referring to FIG. 2, a configuration of one of the pixels 2 will be described in detail as an example. FIG. 2 is a diagram illustrating a circuit configuration of one of the pixels 2. As shown in FIG. 2, each of the pixels 2 includes a driving TFT (pixel switching element) 24, an SRAM (memory circuit) 25, a switch circuit 35, a pixel electrode (first electrode) 21, a common electrode (second electrode) 22, and an electrophoretic element 23.

The driving TFT 24 is an N-MOS (Negative Metal Oxide Semiconductor) transistor, for example. The gate electrode of the driving TFT 24 is connected to a corresponding one of the scanning lines 4, the source electrode of the driving TFT 24 is connected to a corresponding one of the data lines 5, and the drain electrode of the driving TFT 24 is connected to an data input terminal P1 included in the SRAM 25.

The SRAM 25 is a C-MOS (Complementary Metal Oxide Semiconductor) SRAM. The SRAM 25 includes two P-MOS (Positive Metal Oxide Semiconductor) transistors 25a and 25b and two N-MOS transistors 25c and 25d. The source electrode of the P-MOS transistor 25a is connected to a positive power supply terminal PH, the drain electrode of the P-MOS transistor 25a is connected to the data input terminal P1, and the gate electrode of the P-MOS transistor 25a is connected to the gate electrode of the N-MOS transistor 25c and a first data output terminal P2. The positive power supply terminal PH is connected to the first power supply line 13.

The source electrode of the P-MOS transistor 25b is connected to the positive power supply terminal PH, the drain electrode of the P-MOS transistor 25b is connected to the first data output terminal P2, and the gate electrode of the P-MOS transistor 25b is connected to a second data output terminal P3. The source electrode of the N-MOS transistor 25c is connected to the data input terminal P1, the drain electrode of the N-MOS transistor 25c is connected to a negative power supply terminal PL, and the gate electrode of the N-MOS transistor 25c is connected to the gate electrode of the P-MOS transistor 25a and the first data output terminal P2. The negative power supply terminal PL is connected to the second power supply line 14.

The source electrode of the N-MOS transistor 25d is connected to the first data output terminal P2, the drain electrode of the N-MOS transistor 25d is connected to the negative power supply terminal PL, and the gate electrode of the N-MOS transistor 25d is connected to the second data output terminal P3. Furthermore, the data input terminal P1 is connected to the second data output terminal P3.

The SRAM 25 is a memory circuit which has one input terminal and two output terminals and which is capable of storing 1-bit image data therein. In the SRAM 25, when an image signal representing image data “1”, i.e., a high-level image signal, is supplied to the data input terminal P1, a low-level signal is output from the first data output terminal P2 and a high-level signal is output from the second data output terminal P3.

The switch circuit 35 includes a first transmission gate 36 and a second transmission gate 37. The first transmission gate 36 includes an N-MOS transistor 36a and a P-MOS transistor 36b. The source electrode of the N-MOS transistor 36a and the source electrode of the P-MOS transistor 36b are connected to the first control line 11 through a signal input terminal P4. The drain electrode of the N-MOS transistor 36a and the drain electrode of the P-MOS transistor 36b are connected to the pixel electrode 21 through a signal output terminal P5. The gate electrode of the N-MOS transistor 36a is connected to the second data output terminal P3 included in the SRAM 25, and the gate electrode of the P-MOS transistor 36b is connected to the first data output terminal P2 included in the SRAM 25.

The second transmission gate 37 includes an N-MOS transistor 37a and a P-MOS transistor 37b. The source electrode of the N-MOS transistor 37a and the source electrode of the P-MOS transistor 37b are connected to the second control line 12 through a signal input terminal P6. The drain electrode of the N-MOS transistor 37a and the drain electrode of the P-MOS transistor 37b are connected to the pixel electrode 21 through a signal output terminal P7. The gate electrode of the N-MOS transistor 37a is connected to the first data output terminal P2 included in the SRAM 25, and the gate electrode of the P-MOS transistor 37b is connected to the second data output terminal P3 included in the SRAM 25.

When image data “1” is stored in the SRAM 25, a low-level signal is output from the first data output terminal P2, and a high-level signal is output from the second data output terminal P3, the first transmission gate 36 is turned on and a first driving signal supplied through the first control line 11 to the signal input terminal P4 is further supplied through the signal output terminal P5 to the pixel electrode 21. On the other hand, when image data “0” is stored in the SRAM 25, a high-level signal is output from the first data output terminal P2, and a low-level signal is output from the second data output terminal P3, the second transmission gate 37 is turned on and a second driving signal supplied through the second control line 12 to the signal input terminal P6 is further supplied through the signal output terminal P7 to the pixel electrode 21.

The pixel electrode 21 is formed of an Al (aluminum), for example, and is used to apply a voltage to the electrophoretic element 23. The pixel electrode 21 is electrically connected to the signal output terminal P5 of the first transmission gate 36 and the signal output terminal P7 of the second transmission gate 37. The common electrode 22 serves as a counter electrode for the pixel electrode 21, is a transparent electrode formed of an MgAg (magnesium-silver alloy), an ITO (indium tin oxide), or an IZO (indium zinc oxide), for example, and is electrically connected to the common electrode power supply line 15. The electrophoretic element 23 is sandwiched between the pixel electrode 21 and the common electrode 22 and is used to display an image using an electric field generated due to a potential difference generated between the pixel electrode 21 and the common electrode 22.

FIG. 3 is a partially sectional view of the display unit 3 included in the electrophoretic display device 1. The display unit 3 is configured such that electrophoretic elements 23 are sandwiched between an element substrate 28 having the pixel electrodes 21 formed thereon and a counter substrate 29 having the common electrode 22 formed thereon. Each of the electrophoretic elements 23 includes a plurality of microcapsules 40. The electrophoretic elements 23 are fixed between the element substrate 28 and the counter substrate 29 using adhesive layers 30.

The element substrate 28 is a rectangular substrate formed of a glass or plastic material. The pixel electrodes 21 are formed on the element substrate 28, and each of the pixel electrodes 21 has a rectangular shape, and the pixel electrodes 21 correspond to the pixels 2. Although not shown, the scanning lines 4, the data lines 5, the first control line 11, the second control line 12, the first power supply line 13, the second power supply line 14, the common electrode power supply line 15, the driving TFTs 24, the SRAMs 25, and the switch circuits 35 shown in FIGS. 1 and 2 are arranged in regions between the pixel electrodes 21 and on lower surfaces of the pixel electrodes 21. The counter substrate 29 is arranged on an image-display side, and is formed of material having translucency, such as a glass, and has a rectangular shape.

FIG. 4 shows a configuration of one of the microcapsules 40. Each of the microcapsules 40 has a diameter of approximately 50 μm, for example, and is formed of acrylic resin such as polymethylmethacrylate and polyethylmethacrylate, or polymer resin having translucency such as urea resin and gum arabic. The microcapsules 40 are sandwiched between the common electrode 22 and the pixel electrodes 21. Each of the pixels 2 includes the plurality of microcapsules 40 arranged in a matrix. Binders (not shown) are arranged around the microcapsules 40 so as fix the microcapsules 40. Each of the microcapsules 40 includes a dispersion medium 41, a plurality of white particles 42 and a plurality of black particles 43 which are charged particles serving as electrophoretic particles.

Examples of the dispersion medium 41 are water, alcohols solvents such as methanol, ethanol, isopropanol, butanol, octanol, and methyl cellosolve, various esters such as ethyl acetate and butyl acetate, ketones such as acetone, methyl ethyl ketone, and methyl isobutyl ketone, aliphatic hydrocarbons such as pentan, hexane, and octane, alicyclic hydrocarbons such as cyclohexane and methylcyclohexane, aromatic hydrocarbons including benzenes having long-chain alkyl groups such as benzene, toluene, xylene, hexylbenzene, hebutylbenzene, octylbenzene, nonylbenzene, decylbenzene, undecylbenzene, dodecylbenzene, tridecylbenzene, and tetradecylbenzene, halogenated hydrocarbons such as methylene chloride, chloroform, carbon tetrachloride, and 1,2-dichloroethane, carboxylates, and various oils, and mixtures thereof in which a surface-active agent is added. The dispersion medium 41 is used to disperse the white particles 42 and the black particles 43 in the microcapsules 40.

The white particles 42 are, for example, negatively charged particles (macromolecules or colloids) formed of white pigment such as titanium dioxide, zinc oxide, or antimony trioxide.

The black particles 43 are, for example, positively charged particles (macromolecules or colloids) formed of black pigment such as aniline black or carbon black.

Accordingly, the white particles 42 and the black particles 43 are movable in electric fields generated due to potential differences generated between the pixel electrodes 21 and the common electrode 22.

Note that an electrolyte, a surface-active agent, metal soap, resin, rubber, oil, varnish, a charging control agent including compound particles, for example, a dispersant such as a titanium coupling agent, an aluminum coupling agent, or a silane coupling agent, a lubricant agent, and a stabilizing agent may be added to the pigment as needed.

The white particles 42 and the black particles 43 are surrounded by ions in a solvent, and are coated with ion films 44. Electric double layers are formed between the charged white particles 42 and the ion films 44 and between the charged black particles 43 and the ion films 44. In general, even when electric fields having frequencies of 10 kHz or more are applied to the charged particles, that is, the white particles 42 and the black particles 43, the charged particles hardly react to the electric fields, and therefore, hardly move. It is known that since the ions surrounding the charged particles have diameters considerably smaller than those of the charged particles, when electric fields having frequencies of 10 kHz or more are applied to the ions surrounding the charged particles, the ions surrounding the charged particles move in accordance with the electric fields.

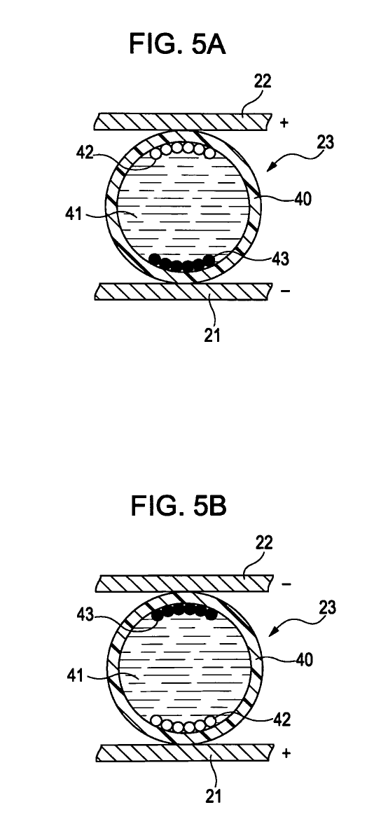

FIGS. 5A and 5B are diagrams illustrating operation of one of the plurality of microcapsules. A case where the ion films 44 are not formed in the microcapsules 40, which is an ideal case, will be described as an example. When voltages are applied so that a voltage of the common electrode 22 are relatively higher than those of the pixel electrodes 21, the black particles 43 which are positively charged are attracted to the side of the pixel electrode 21 in the microcapsules 40 by the Coulomb force as shown in FIG. 5A. On the other hand, the white particles 42 which are negatively charged are attracted to the side of the common electrode 22 in the microcapsules 40 by the Coulomb force. That is, the white particles 42 are collected on the side of the display surface in the microcapsules 40, and color (white) of the white particles 42 is displayed on the display surface.

On the other hand, when voltages are applied so that voltages of the pixel electrodes 21 are relatively higher than that of the common electrode 22, the white particles 42 which are negatively charged are attracted to the side of the pixel electrodes 21 by the Coulomb force, whereas the black particles 43 which are positively charged are attracted to the side of the common electrode 22 by the Coulomb force. That is, the black particles 43 are collected on the side of the display surface in the microcapsules 40, and color (black) of the black particles 43 is displayed on the display surface.

Note that when red pigment, green pigment, or blue pigment are used for the white particles 42 and the black particles 43, the electrophoretic display device 1 capable of displaying red, green, or blue can be attained.

### Method for Driving Electrophoretic Display Device

Operation of (a method for driving) the electrophoretic display device 1 configured as described above according to the embodiment will now be described.

### 1. Black and White Display

First, pieces of image data should be stored in the SRAMs 25 included in the pixels 2. In this embodiment, a period in which the pieces of image data are stored in the SRAMs 25 is referred to as a “data writing period”. In this data writing period, the controller 10 controls the common power supply modulation circuit 8 to supply power supply voltage signals corresponding to a direct current of 5V to the SRAMs 25 included in the pixels 2 through the first power supply line 13, and to connect the second power supply line 14 to the ground line. Furthermore, the common power supply modulation circuit 8 electrically breaks the first control line 11, the second control line 12, and the common electrode power supply line 15. That is, the first control line 11, the second control line 12, and the common electrode power supply line 15 are brought into opened states resulting in high impedance states.

Then, in the data writing period, the controller 10 controls the data line driving circuit 7 to supply pulsed image signals which include low-level signals representing pieces of image data “0” used for white display and high-level signals representing pieces of image data “1” used for black display, through the data lines 5 including the first data line to the n-th data line to the pixels 2. The controller 10 also controls the scanning line driving circuit 6 to successively select the scanning lines 4 including the first scanning line to the m-th scanning line so that selection signals representing timings when the driving TFTs are turned on are supplied to the pixels 2. Accordingly, in the data writing period, the low-level image signals representing the pieces of image data “0” used for white display and the high-level image signals representing the pieces of image data “1” used for black display are stored in the SRAMs 25 included in the pixels 2.

Then, high-level signals of 5V are output from the first data output terminals P2 of the SRAMs 25 which stores the low-level image signals therein, and low-level signals corresponding to the ground level are output from the second data output terminals P3 of the SRAMs 25 which stores the low-level image signals therein. Accordingly, the second transmission gates 37 are turned on. However, since the second control line 12 is in a high impedance state, the pixel electrodes 21 are also brought into high impedance states. Furthermore, low-level signals are output from the first data output terminals P2 of the SRAMs 25 which stores the high-level image signals therein, and high-level signals are output from the second data output terminals P3 of the SRAMs 25 which stores the high-level image signals therein. Accordingly, the first transmission gates 36 are turned on. However, since the first control line 11 is in a high-impedance state, the pixel electrodes 21 are also brought into high impedance states. Accordingly, in the data writing period, since voltages are not applied to the pixel electrodes 21 and the common electrode 22 included in the pixels 2, the electrophoretic elements 23 do not operate.

After the data writing period is terminated, a display period is entered. In the display period, the controller 10 controls the common power supply modulation circuit 8 to supply power supply voltage signals corresponding to direct currents of 15V through the first power supply line 13 to the SRAMs 25 included in the pixels 2, and to connect the second power supply line 14 to the ground line. Furthermore, the common power supply modulation circuit 8 electrically makes the first control line 11, the second control line 12, and the common electrode power supply line 15. That is, the common power supply modulation circuit 8 supplies high-level first driving signals of 15V through the first control line 11 to the pixels 2, supplies low-level second driving signals through the second control line 12 to the pixels 2, and supplies a common voltage signal through the common electrode power supply line 15 to the common electrode 22. Here, a pulse signal having amplitude of 15V is used as the common voltage signal.

Accordingly, since high-level signals of 15V are output from the first data output terminals P2 of the SRAMs 25 which store the low-level image signals whereas low-level signals are output from the second data output terminals P3 of the SRAMs 25 which store the low-level image signals, the second transmission gate 37s are turned on. That is, the low-level second driving signals are supplied through the second transmission gates 37 to the pixel electrodes 21. Consequently, in the electrophoretic elements 23 which are included in the pixels 2 and which correspond to the SRAMs 25 storing the low-level image signals therein, since the white particles 42 move to the side of the common electrode 22 (on the display surface side) and the black particles 43 move to the side of the pixel electrodes 21 as shown in FIG. 5A, white display is performed.

On the other hand, since high-level signals of 15V are output from the second data output terminals P3 of the SRAMs 25 which store the high-level image signals, and low-level signals are output from the first data output terminals P2 of the SRAMs 25 which store the high-level image signals, the first transmission gates 36 are turned on. That is, the high-level first driving signals are supplied to the pixel electrode 21 through the first transmission gates 36. Consequently, in the electrophoretic elements 23 which are included in the pixels 2 and which correspond to the SRAMs 25 storing the high-level image signals therein, since the black particles 43 move to the side of the common electrode 22 (on the display surface side) and the white particles 42 move to the side of the pixel electrodes 21 as shown in FIG. 5B, black display is performed. In this way, the black and white screen can be displayed on the display unit 3 by the operations described above. Furthermore, when the display screen is to be changed, operations similar to those described above may be performed starting from the data writing period.

Note that when black and white reversed display is performed, the first driving signals are controlled to be a low level and the second driving signals are controlled to be a high level. In a case where an image is continued to be displayed after the image is stably displayed, that is, after the black particles 43 or the white particles 42 sufficiently move to the side of the common electrode 22, the common power supply modulation circuit 8 preferably breaks the first control line 11, the second control line 12, the first power supply line 13, the second power supply line 14, and the common electrode power supply line 15. In this way, charge held between the pixel electrodes 21 and the common electrode 22 is prevented from leaking as current leakage from the first control line 11, the first power supply line 13, the second power supply line 14, the second control line 12, and the common electrode power supply line 15. Accordingly, display quality is prevented from being deteriorated.

Furthermore, not only the black and white display, display using a first tone and a second tone other than black and white may be performed. In this case, when it is assumed that image data corresponding to the first tone is represented by “0”, and image data corresponding to the second tone is represented by “1”, first driving signals representing the first tone may be supplied to the first control line 11 and second driving signals representing the second tone may be supplied to the second control line 12. Note that voltage values or pulse widths of driving signals may be controlled in order to determine a tone. Since the first transmission gates 36 and the second transmission gates 37 allow the first driving signals and the second driving signals having voltage values within a range of the power supply voltage (within 15V) of the SRAMs 25 to be supplied to the pixel electrodes 21, the first transmission gates 36 and the second transmission gates 37 can arbitrarily control voltage values of the first driving signals and the second driving signals within the range of the power supply voltage of the SRAMs 25.

### Full White Display

A method for performing full white display (when an image of a single tone is displayed) is selected from among two methods in accordance with whether pieces of image data have already been stored in the SRAMs 25 (display forms of the pieces of image data are not considered). First, an operation performed in a case where the pieces of image data have already been stored in the SRAMs 25, that is, in a case where the black and white display is performed as described above, so that the black and white display described above is changed to the full white display will be described.

In the case where the pieces of image data have already been stored in the SRAMs 25, in each of the SRAMs 25, one of the first transmission gate 36 and the second transmission gate 37 is turned on. Here, all the pixel electrodes 21 receive low-level driving signals irrespective of the pieces of image data stored in the SRAMs 25 by controlling the first driving signals supplied through the first control line 11 and the second driving signals supplied through the second control line 12 to be a low level using the common power supply modulation circuit 8. Here, pulsed common voltage signal having amplitude of 15V or a high-level common voltage signal of 15V which is a constant signal may be supplied to the common electrode 22. As described above, when the pieces of image data have already been stored in the SRAMs 25, the data writing period is eliminated and the black and white display can be switched to the full white display.

On the other hand, in a case where the pieces of image data have not yet been stored in the SRAMs 25, as with the black and white display described above, image signals representing pieces of image data “0” for white display may be stored in the SRAMs 25 included in all the pixels 2 in the data writing period, and low-level second driving signals may be supplied to all the pixels 2 through the second control line 12 in the display period. Note that, at this time, the common power supply modulation circuit 8 should break the first control line 11.

### Full Black Display

When full black display is performed (that is, when an image of a single tone is displayed), the operation the same as performed for the full white display is performed. Specifically, in a case where the pieces of image data have already been stored in the SRAMs 25, all the pixel electrodes 21 receive high-level driving signals irrespective of the pieces of image data stored in the SRAMs 25 by controlling the first driving signals supplied through the first control line 11 and the second driving signals supplied through the second control line 12 to be a high level using the common power supply modulation circuit 8. Here, pulsed common voltage signal having amplitude of 15V or a low-level (ground level) common voltage signal of 15V which is a constant signal may be supplied to the common electrode 22. As described above, when the pieces of image data have already been stored in the SRAMs 25, the data writing period is skipped and the full black display is performed.

On the other hand, in a case where the pieces of image data have not yet been stored in the SRAMs 25, as with the black and white display described above, image signals representing pieces of image data “1” for the black display are stored in the SRAMs 25 included in all the pixels 2 in the data writing period, and high-level first driving signals are supplied to all the pixels 2 through the first control line 11 in the display period. Note that the common power supply modulation circuit 8 should break the second control line 12.

Furthermore, when an image of a single tone other than white and black is displayed, that is, when halftone display (gray display) is performed, image signals representing the pieces of image data “1” or image signals representing the pieces of image data “0” are stored in the SRAMs 25 included in all the pixels 2. In a case where the pieces of image data “1” are stored in the SRAMs 25 of all the pixels 2, first driving signals representing halftone are supplied to the first control line 11, whereas in a case where the pieces of image data “0” are stored in the SRAMs 25 of all the pixels 2, second driving signals representing halftone are supplied to the second control line 12.

### Grayscale Display

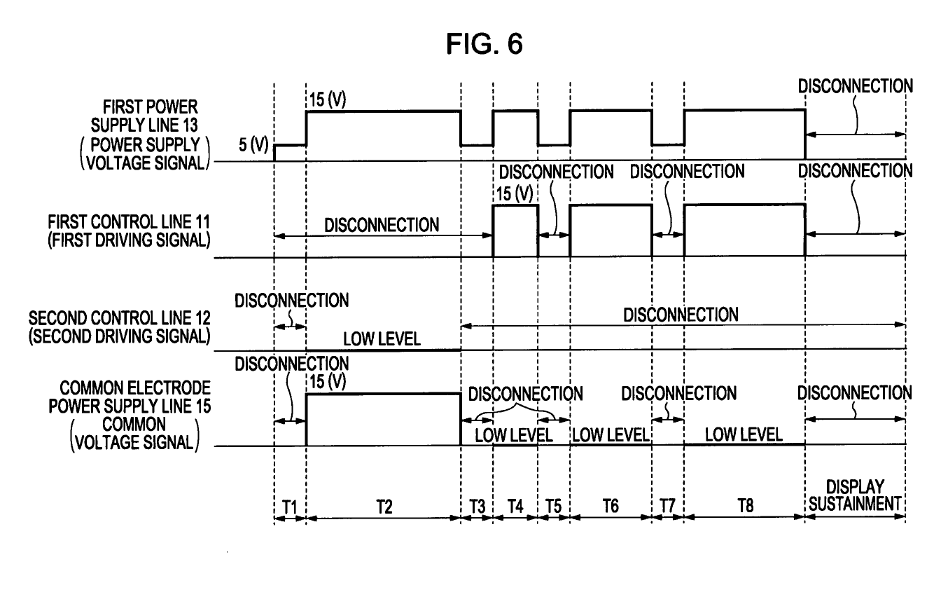

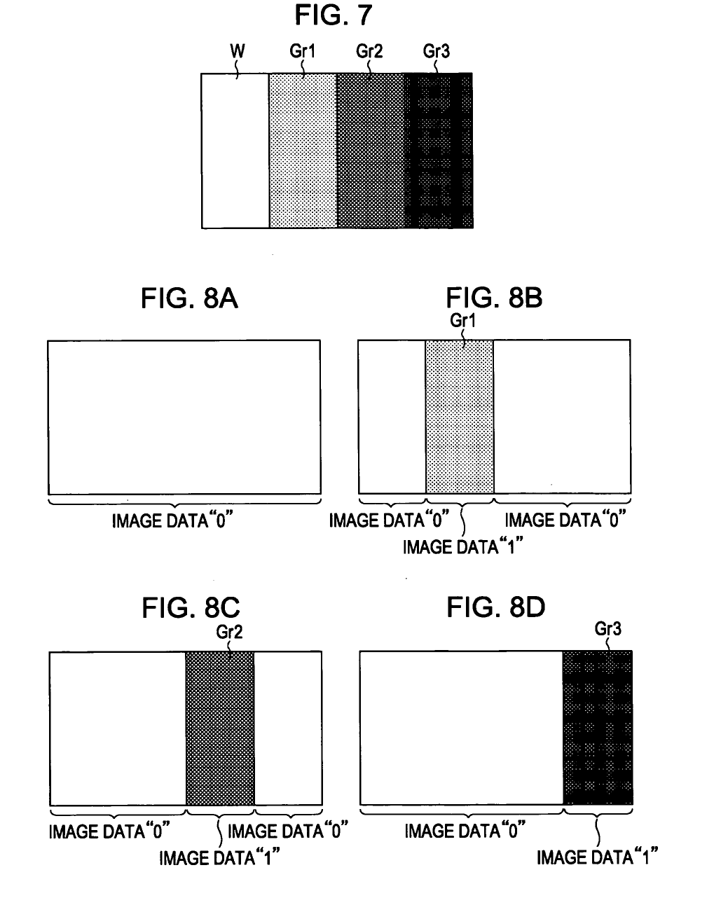

Taking the basic operations described above into consideration, an operation for performing grayscale display (that is, an operation performed when an image having three or more tones is to be displayed) will now be described with reference to a timing chart shown in FIG. 6. Referring to FIG. 7, a case where grayscale display having four tones, i.e., a white tone W, a light gray tone Gr1, a middle gray tone Gr2, and a dark gray tone Gr3 is performed will be described as an example hereinafter. Note that, it is assumed that the SRAMs 25 of the pixels 2 have not stored any pieces of image data therein in an initial state.

First, in a first data writing period T1 of FIG. 6, pieces of image data for full white display as shown in FIG. 8A are stored in the SRAM 25 of all the pixels 2. Specifically, in the first data writing period T1, the controller 10 controls the common power supply modulation circuit 8 to supply power supply voltage signals of direct currents of 5V to the SRAMs 25 of the pixels 2 through the first power supply line 13, and to connect the second power supply line 14 to the ground line. Here, the common power supply modulation circuit 8 electrically breaks the first control line 11, the second control line 12, and the common electrode power supply line 15.

Then, the controller 10 controls the data line driving circuit 7 to supply low-level image signals representing pieces of image data “0” for white display to the pixels 2 through the data lines 5 including the first to the n-th data lines. Furthermore, the controller 10 controls the scanning line driving circuit 6 to successively select the scanning lines 4 including the first to the m-th scanning lines in order to supply selection signals representing timings when the driving TFTs 24 are turned on to the pixels 2. Consequently, in the first data writing period T1, the low-level image signals representing the pieces of image data “0” for white display are stored in the SRAMs 25 included in the pixels 2.

Here, the first data output terminals P2 of the SRAMs 25 which store the low-level image signals therein output high-level signals, whereas the second data output terminals P3 of the SRAMs 25 which store the low-level image signals therein output low-level signals of the ground level. Accordingly, the second transmission gates 37 are turned on and the pixel electrodes 21 are brought into high impedance states since the second control line 12 is in a high impedance state. That is, in the first data writing period T1, since voltages are not applied to the pixel electrodes 21 and the common electrode 22 corresponding to all the pixels 2, the electrophoretic elements 23 do not operate.

Then, in a first display period T2, the controller 10 controls the common power supply modulation circuit 8 to supply power supply voltage signals of direct currents of 15V to the SRAM 25 of the pixels 2 through the first power supply line 13, and to connect the second power supply line 14 to the ground line. Here, the common power supply modulation circuit 8 maintains a disconnection state of the first control line 11 and is electrically connected to the second control line 12 and the common electrode power supply line 15. By this, the common power supply modulation circuit 8 supplies low-level second driving signals to the pixels 2 through the second control line 12, and supplies a high-level common voltage signal of 15V which is a constant signal to the common electrode 22 through the common electrode power supply line 15. Note that a pulse signal having amplitude of 15V may be supplied as the common voltage signal.

Accordingly, since the first data output terminals P2 of the SRAMs 25 of all the pixels 2 output high-level signals of 15V whereas the second data output terminals P3 of the SRAMs 25 of all the pixels 2 output low-level signals, the second transmission gates 37 are turned on. That is, the low-level second driving signals are supplied to the pixel electrode 21 of all the pixels 2 through the second transmission gates 37, and accordingly, full white display is performed. Note that the first display period T2 is set taking a period in which the white particles 42 sufficiently move to the side of the common electrode 22 so that stable display is attained into consideration.

Subsequently, in a second data writing period T3, pieces of image data used to display the light gray tone Gr1 as shown in FIG. 8B are stored in SRAMs 25 included in the pixels 2. Specifically, image signals representing pieces of image data “1” are stored in, among all the SRAMs 25, SRAMs 25 included in the pixels 2 corresponding to the light gray tone Gr1, and image signals representing pieces of image data “0” are stored in, among all the SRAMs 25, SRAMs 25 included in the pixels 2 corresponding to the other tones. An operation of storing the image signals are similar to that described above, and therefore, description thereof is omitted.

Accordingly, the first transmission gates 36 are turned on in the pixels 2 corresponding to the light gray tone Gr1, whereas the second transmission gates 37 are turned on in the pixels 2 corresponding to the other tones. Note that, as with the first data writing period T1, power supply voltage signals corresponding to direct currents of 5V are supplied to the SRAMs 25 of the pixels 2 through the first power supply line 13, the second power supply line 14 is connected to the ground line, and the first control line 11, the second control line 12, and the common electrode power supply line 15 are in electrically-disconnection states in the second data writing period T3.

Then, in a second display period T4, the controller 10 controls the common power supply modulation circuit 8 to supply power voltage signals corresponding to direct currents of 5V to the SRAMs 25 included in the pixels 2 through the first power supply line 13, and to connect the second power supply line 14 to the ground line. Here, the common power supply modulation circuit 8 maintains a disconnection state of the second control line 12 and is electrically connected to the first control line 11 and the common electrode power supply line 15. By this, the common power supply modulation circuit 8 supplies pulsed first driving signals of a high-level (15V) to the pixels 2 through the first control line 11, and supplies a low-level common voltage signal to the common electrode 22 through the common electrode power supply line 15.

Accordingly, the high-level first driving signals are supplied only to the pixel electrodes 21 of the pixels 2 corresponding to the light gray tone Gr1 through the first transmission gates 36, and the black particles 43 move to the side of the common electrode 22. Here, levels of tones of the pixels 2 corresponding to the light gray tone Gr1 are changed in accordance with pulse widths (duration of the second display period T4) of the first driving signals. For example, the smaller the pulse widths of the first driving signals are, the smaller the number of the black particles 43 which move to the side of the common electrode 22 is (and the smaller the number of the white particles 42 which move to the side of the pixel electrodes 21 is), and the pixels 2 become corresponding to light gray. That is, levels of the light gray tone Gr1 are determined in accordance with the pulse widths of the first driving signals (duration of the second display period T4). At this time, the light gray tone Gr1 and another tone (white) are displayed.

Next, in a third data writing period T5, pieces of image data used to display the middle gray tone Gr2 as shown in FIG. 8C are stored in the SRAMs 25 included in the pixels 2. Specifically, image signals representing pieces of image data “1” are stored in, among all the SRAMs 25, SRAMs 25 included in the pixels 2 corresponding to the middle gray tone Gr2, and image signals representing pieces of image data “0” are stored in, among all the SRAMs 25, SRAMs 25 included in the pixels 2 corresponding to the other tones. An operation of storing the image signals are similar to that described above, and therefore, description thereof is omitted.

Accordingly, the first transmission gates 36 are turned on in the pixels 2 corresponding to the middle gray tone Gr2, whereas the second transmission gates 37 are turned on in the pixels 2 corresponding to the other tones. Note that, as with the first data writing period T1, power supply voltage signals corresponding to direct currents of 5V are supplied to the SRAMs 25 of the pixels 2 through the first power supply line 13, the second power supply line 14 is connected to the ground line, and the first control line 11, the second control line 12, and the common electrode power supply line 15 are in electrically-disconnection states in the third data writing period T5.

Then, in a third display period T6, the controller 10 controls the common power supply modulation circuit 8 to supply power voltage signals corresponding to direct currents of 15V to the SRAMs 25 included in the pixels 2 through the first power supply line 13, and to connect the second power supply line 14 to the ground line. Here, the common power supply modulation circuit 8 maintains a disconnection state of the second control line 12 and is electrically connected to the first control line 11 and the common electrode power supply line 15. By this, the common power supply modulation circuit 8 supplies pulsed first driving signals of a high-level (15V) to the pixels 2 through the first control line 11, and supplies a low-level common voltage signal to the common electrode 22 through the common electrode power supply line 15.

Accordingly, the high-level first driving signals are supplied only to the pixel electrodes 21 of the pixels 2 corresponding to the middle gray tone Gr2 through the first transmission gates 36, and the black particles 43 move to the side of the common electrode 22. Here, levels of tones of the pixels 2 corresponding to the middle gray tone Gr2 are changed in accordance with pulse widths (duration of the third display period T6) of the first driving signals (the third display period T6 is longer than the second display period T4). At this time, the light gray tone Gr1, the middle gray tone Gr2, and another tone (white) are displayed.

Subsequently, in a fourth data writing period T7, pieces of image data used to display the dark gray tone Gr3 as shown in FIG. 8D are stored in the SRAMs 25 included in the pixels 2. Specifically, image signals representing pieces of image data “1” are stored in, among all the SRAMs 25, SRAMs 25 included in the pixels 2 corresponding to the dark gray tone Gr3, and image signals representing pieces of image data “0” are stored in, among all the SRAMs 25, SRAMs 25 included in the pixels 2 corresponding to the other tones. An operation of storing the image signals are similar to that described above, and therefore, description thereof is omitted.

Accordingly, the first transmission gates 36 are turned on in the pixels 2 corresponding to the dark gray tone Gr3, whereas the second transmission gates 37 are turned on in the pixels 2 corresponding to the other tones. Note that, as with the first data writing period T1, power supply voltage signals corresponding to direct currents of 5V are supplied to the SRAMs 25 of the pixels 2 through the first power supply line 13, the second power supply line 14 is connected to the ground line, and the first control line 11, the second control line 12, and the common electrode power supply line 15 are in electrically-disconnection states in the fourth data writing period T7.

Then, in a fourth display period T8, the controller 10 controls the common power supply modulation circuit 8 to supply power voltage signals corresponding to direct currents of 15V to the SRAMs 25 included in the pixels 2 through the first power supply line 13, and to connect the second power supply line 14 to the ground line. Here, the common power supply modulation circuit 8 maintains a disconnection state of the second control line 12 and is electrically connected to the first control line 11 and the common electrode power supply line 15. By this, the common power supply modulation circuit 8 supplies pulsed first driving signals of a high-level (15V) to the pixels 2 through the first control line 11, and supplies a low-level common voltage signal to the common electrode 22 through the common electrode power supply line 15.

Accordingly, the high-level first driving signals are supplied only to the pixel electrodes 21 of the pixels 2 corresponding to the dark gray tone Gr3 through the first transmission gates 36, and the black particles 43 move to the side of the common electrode 22. Here, levels of tones of the pixels 2 corresponding to the dark gray tone Gr3 are changed in accordance with pulse widths (duration of the fourth display period T8) of the first driving signals (the fourth display period T8 is longer than the third display period T6). At this time, the grayscale display as shown in FIG. 7 is attained.

Thereafter, the common power supply modulation circuit 8 preferably breaks the first control line 11, the second control line 12, the first power supply line 13, the second power supply line 14, and the common electrode power supply line 15 so that deterioration of display quality is prevented.

Note that although the levels of gray tones are determined by controlling the pulse widths of the pulse signals (first driving signals) applied to the pixel electrodes 21 in the forgoing embodiment, the present invention is not limited to this. The levels of the gray tones may be determined in accordance with combinations of voltages of the pulse signals and the pulse widths.

Furthermore, in the forgoing embodiment, in the first data writing period T1 and the first display period T2 (hereinafter referred to as a “first combination operation”), the pieces of image data having values of “0” are stored in the SRAMs 25 of all the pixels 2 in the first data writing period T1, and the second driving signals (of a low level) which determine a single tone (white tone W) are supplied to the second control line 12 connected to the pixel electrodes 21 of all the pixels 2 in the first display period T2. In this first combination operation, the following operation may be performed. Specifically, in the first data writing period T1, pieces of image data are stored in, among all the SRAMs 25, SRAMs 25 of the pixels 2 corresponding to one (white tone W) of a plurality of tones, and pieces of image data having values different from those stored in the SRAMs 25 of the pixels 2 corresponding to the one (white tone W) of the plurality of tones are stored in, among all the SRAMs 25, SRAMs 25 of the pixels 2 corresponding to the other tones (the light gray tone Gr1, the middle gray tone Gr2, and the dark gray tone Gr3). In this embodiment, the pieces of image data having values of “0” are stored in the SRAMs 25 of the pixels 2 corresponding to the white tone W, whereas the pieces of image data having values of “1” are stored in the SRAMs 25 of the pixels 2 corresponding to the other tones (the light gray tone Gr1, the middle gray tone Gr2, and the dark gray tone Gr3). Then, in the first display period T2, second driving signals representing the white tone W are supplied to the second control line 12 connected to the pixel electrodes 21 of the pixels 2 corresponding to the white tone W, and the first control line 11 is electrically disconnected from the pixel electrode 21 of the pixels 2 corresponding to the other tones (the light gray tone Gr1, the middle gray tone Gr2, and the dark gray tone Gr3). A pulsed common voltage signal having amplitude of 15V or a high-level common voltage signal of 15V which is a constant signal is supplied to the common electrode 22.

Furthermore, in a case where some sort of display was performed before the grayscale display is performed, and therefore, pieces of image data have already been stored in the SRAM 25 of the pixels 2, in the first combination operation, the first data writing period T1 may be skipped and the operation for attaining the full white display described above is performed in the first display period T2. That is, the common power supply modulation circuit 8 controls the first driving signals supplied through the first control line 11 and the second driving signals supplied through the second control line 12 to be a low level, and the pulsed common voltage signal having an amplitude of 15V or the high-level common voltage signal of 15V which is a constant signal is supplied to the common electrode 22.

In the forgoing embodiment, when the pieces of image data “1” are stored in the SRAMs 25, the first driving signals used for the black display or the gray display are supplied to the first control line 11 whereas when the pieces of image data “0” are stored in the SRAMs 25, the second driving signals used for the white display are supplied to the second control line 12. However, the present invention is not limited to this. When the pieces of image data “0” are stored in the SRAMs 25, the second driving signals used to the black display or the gray display may be supplied to the second control line 12, whereas when the pieces of image data “1” are stored in the SRAM 25, the first driving signals used for the white display may be supplied to the first control line 11.

As described above, according to the electrophoretic display device 1 of this embodiment, electronic fields to be applied to the electrophoretic elements 23 may be controlled with high accuracy, and high-quality gradation display is attained.

### Electronic Apparatus

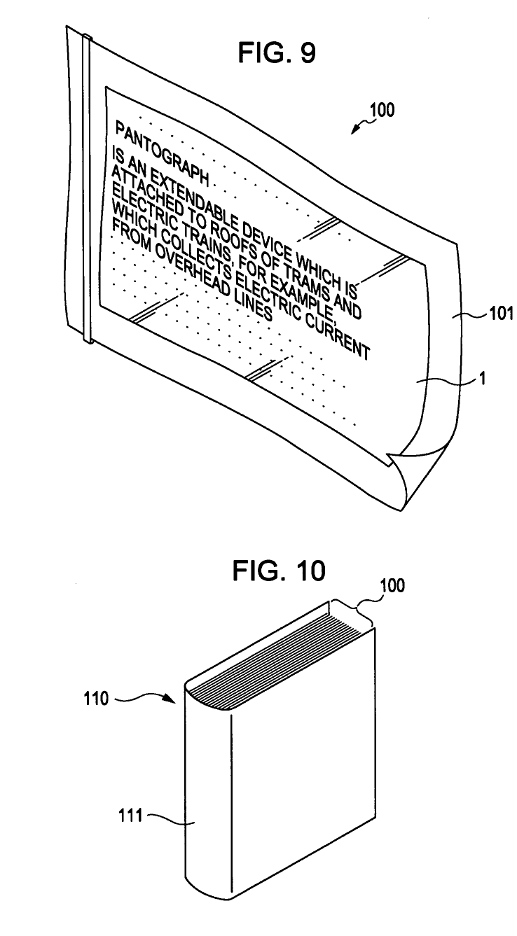

Next, an electronic apparatus including the electrophoretic display device 1 described above will be described as an example. An example in which the electrophoretic display device 1 is employed in a flexible electronic sheet will now be described. FIG. 9 is a perspective view illustrating a configuration of an electronic sheet 100. The electronic sheet 100 includes the electrophoretic display device 1 as a display unit. The electronic sheet 100 is formed such that the electrophoretic display device 1 is arranged on a surface of a body 101 formed of a sheet which has texture similar to general sheets and which has flexibility.

FIG. 10 is a perspective view illustrating a configuration of an electronic note 110. The electronic note 110 includes a plurality of electronic sheets 100 of FIG. 9 which are bound and inserted into a cover 111. The cover 111 includes a display data input unit (not shown), for example, used to input display data supplied from an external apparatus. Accordingly, items to be displayed are changed or updated in accordance with the display data while the plurality of the electronic sheets 100 are bound.

In addition to the examples described above, other examples include liquid crystal television sets, video-tape recorders having a viewfinder or a monitor directly viewed by a user, car navigation devices, pagers, electronic notebooks, calculators, word processors, work stations, videophones, POS terminals, and apparatuses having touch panels. The electrophoretic display device 1 may be employed as a display unit for such electronic apparatuses.

What is claimed is:

1. An electrophoretic display device comprising:
a plurality of pixels which are connected to scanning lines, data lines, a first control line, and a second control line, and which have first electrodes, a second electrode facing the first electrodes, electrophoretic elements which are sandwiched between the first electrodes and the second electrode and which have charged electrophoretic particles, pixel switching elements connected to the scanning lines and the data lines, memory circuits which are connected to the pixel switching elements, which store therein pieces of 1-bit data supplied through the data lines and the pixel switching elements, and which output signals representing the pieces of 1-bit data, and switch circuits which are arranged between the memory circuits and the first electrodes and which electrically connect the first control line or the second control line to the first electrodes; and
a signal supply unit which supplies first driving signals determining tones of, among the plurality of pixels, pixels having the first electrodes connected to the first control line to the first control line, and which supplies second driving signals determining tones of, among the plurality of pixels, pixels having the first electrodes connected to the second control line to the second control line.

2. The electrophoretic display device according to claim 1, further comprising:
a data line driving circuit which supplies the pieces of 1-bit data to the data lines; and
a scanning line driving circuit which supplies selection signals representing timings when the pixel switching elements are turned on to the scanning lines,
wherein, in a data writing period, the data line driving circuit supplies the pieces of 1-bit data to the data lines and the scanning line driving circuit supplies the selection signals to the successively selected scanning lines so that the memory circuits of the pixels stores the pieces of 1-bit data, and
in a display period, the signal supply unit supplies the first driving signals to the first control line and supplies the second driving signals to the second control line.

3. The electrophoretic display device according to claim 2,
wherein, when an image of a single tone is to be displayed, in the data writing period, the data line driving circuit supplies pieces of 1-bit data having the same values to the data lines so that the pieces of 1-bit data having the same values are stored in the memory circuits of all the pixels, and in the display period, the signal supply unit supplies first driving signals or second driving signals which represent the single tone to the first control line or the second control line which is connected to the first electrodes of all the pixels.

4. The electrophoretic display device according to claim 2,
wherein, when the image of a single tone is to be displayed and when the pieces of 1-bit data have already been stored in the memory circuits of all the pixels, the data writing period is skipped and the display period is entered, and the signal supply unit supplies the first driving signals representing the single tone to the first control line and supplies the second driving signals representing the single tone to the second control line.

5. The electrophoretic display device according to claim 2,
wherein when an image having three or more tones is to be displayed, a combination of two operations is performed on each of the three or more tones, the two operations including an operation of storing pieces of 1-bit data in, among the memory circuits, memory circuits of the pixels corresponding to one of the three or more tones and storing pieces of 1-bit data, which are different from those stored in the memory circuits of the pixels corresponding to the one of the three or more tones, in memory circuits of the other pixels in the data writing period using the data line driving circuit and the scanning line driving circuit, and an operation of supplying first driving signals or second driving signals which represent the one of the three or more tones to the first control line or the second control line which is connected to the first electrodes of the pixels corresponding to the one of the three or more tones using the signal supply unit, and electrically disconnecting the first control line or the second control line from the first electrodes of the memory circuits of the other pixels in the display period.

6. The electrophoretic display device according to claim 5,
wherein when the combination of two operations is first performed, in the data writing period, pieces of 1-bit data having the same values are stored in the memory circuits of all the pixels using the data line driving circuit and the scanning line driving circuit, and in the display period, first driving signals or second driving signals which represent the one of the three or more tones are supplied to the first control line or the second control line which is connected to the first electrodes of all the pixels.

7. The electrophoretic display device according to claim 5,
wherein when the combination of two operations is first performed and when pieces of 1-bit data have already been stored in the memory circuits of all the pixels, the data writing period is skipped and the display period is entered, and the signal supply unit supplies first driving signals representing the one of the three or more tones to the first control line, and supplies second driving signals representing the one of the three or more tones to the second control line.

8. The electrophoretic display device according to claim 1,
wherein the plurality of pixels are connected to a positive power supply line and a negative power supply line,
the memory circuits are SRAMs (Static Random Access Memory) which have positive power supply terminals connected to the positive power supply line and negative power supply terminals connected to the negative power supply line,
the switch circuits have first transmission gates used to connect the first electrodes to the first control line in accordance with first signals output from the SRAMs and second transmission gates used to connect the first electrodes to the second control line in accordance with second signals output from the SRAMs, and
the signal supply unit supplies power supply voltage signals to the positive power supply line and the negative power supply line and supplies a common voltage signal to the second electrode.

9. The electrophoretic display device according to claim 8,
wherein the signal supply unit supplies the power voltage signals to the positive power supply line and the negative power supply line in the data writing period and in the display period, and the signal supply unit electrically breaks the first control line, the second control line and a line for supplying the common voltage signal in the data writing period.

10. The electrophoretic display device according to claim 8, wherein when an image is continued to be displayed after the display period, the signal supply unit electrically breaks the positive power supply line, the negative power supply line, the first control line, the second control line, and the line for supplying the common voltage signal.

11. A method for driving an electrophoretic display device including a plurality of pixels having first electrodes, a second electrode facing the first electrodes, electrophoretic elements which are sandwiched between the first electrodes and the second electrode and which have charged electrophoretic particles, the method comprising:
storing pieces of 1-bit data in memory circuits included in the plurality of pixels;
electrically connecting a first control line or a second control line to the first electrodes using switch circuits arranged between the memory circuits and the first electrodes in accordance with the pieces of 1-bit data stored in the memory circuits; and
supplying first driving signals representing tones of, among the plurality of pixels, pixels connected to the first control line from the first electrodes to the first control line, and supplying second driving signals representing tones of, among the plurality of pixels, pixels connected to the second control line from the first electrodes to the second control line.

12. An electronic apparatus comprising the electrophoretic display device set forth in claim 1.
